(19) United States
(12) Patent Application Publication
(10) Pub. No.: US 2022/0261100 A1
(43) Pub. Date: Aug. 18, 2022

(54) Solar Powered Digital Interactive Memorial

(71) Applicants: Ksenija Dreu, Trnovska vas (SI); Sasa Radovanovic, Maribor (SI)

(72) Inventors: Ksenija Dreu, Trnovska vas (SI); Sasa Radovanovic, Maribor (SI)

(21) Appl. No.: 17/672,675

(22) Filed: Feb. 15, 2022

Related U.S. Application Data
(60) Provisional application No. 63/149,604, filed on Feb. 15, 2021.

(51) Int. Cl. G06F 3/041; G06V 40/12; G06V 40/16; G09G 3/00; G10L 17/00; H04R 1/02; H04R 3/00

(52) U.S. Cl. CPC G06F 3/041; G06V 40/1365; G06V 40/172; G09G 3/002; H04R 2499/15; H04R 1/028; H04R 3/00; G09G 2354/00; G10L 17/00

(57) ABSTRACT

A solar powered digital interactive memorial has at least one memorial unit, at least one solar panel, and at least one power storage unit electrically connected to each other. Each memorial unit has a housing, a digital display, an illuminated display recess, one or more sensors, a wireless communication device, and a processing unit. A proximity sensor detects motion in the vicinity of the unit and deactivates various components of the memorial unit to conserve electricity when not in use. A touchscreen display provided as the digital display enables users to interact with the memorial unit. Biometric recognition functionality enables delivery of prerecorded audio or visual content to specific individuals. Multiple units may be arranged together into a columbarium configuration or a memorial wall configuration.

The current application claims a priority to the U.S. Provisional Patent application Ser. No. 63/149,604 filed on Feb. 15, 2022.

### FIELD OF THE INVENTION

The present invention relates generally to cemetery gravestones. More particularly, the present invention relates to digital and customizable memorial installations.

### BACKGROUND OF THE INVENTION

It is impossible to live forever as a human being. When someone is to pass away, they are typically buried besides a gravestone that lacks presentation of robust information about the deceased. The information of the deceased found on a gravestone is typically limited to a name, a date of birth, and a date of death. It can be rare to find a photo engraved on the gravestone of the deceased or of the likes. The lack of information presented about the deceased on the cemetery gravestone may be painful for close friends and family because the close friends and family may want other people to know more about the deceased—as to why they were important, and why the deceased will be sincerely missed.

An objective of the present invention is to provide a cemetery gravestone that is able to digitally display additional information about the deceased besides the typical name, date of birth, and date of death. The present invention is a solar powered cemetery gravestone that digitally displays stories and information about the deceased. In addition, the present invention is uniquely configured to capture the emotional loss of a gravestone, columbarium, memorial wall, or of the likes.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show the preferred embodiment of the present invention.

### BRIEF DESCRIPTION OF THE DRAWINGS

FIGS. 1 through 6 illustrate the present invention.

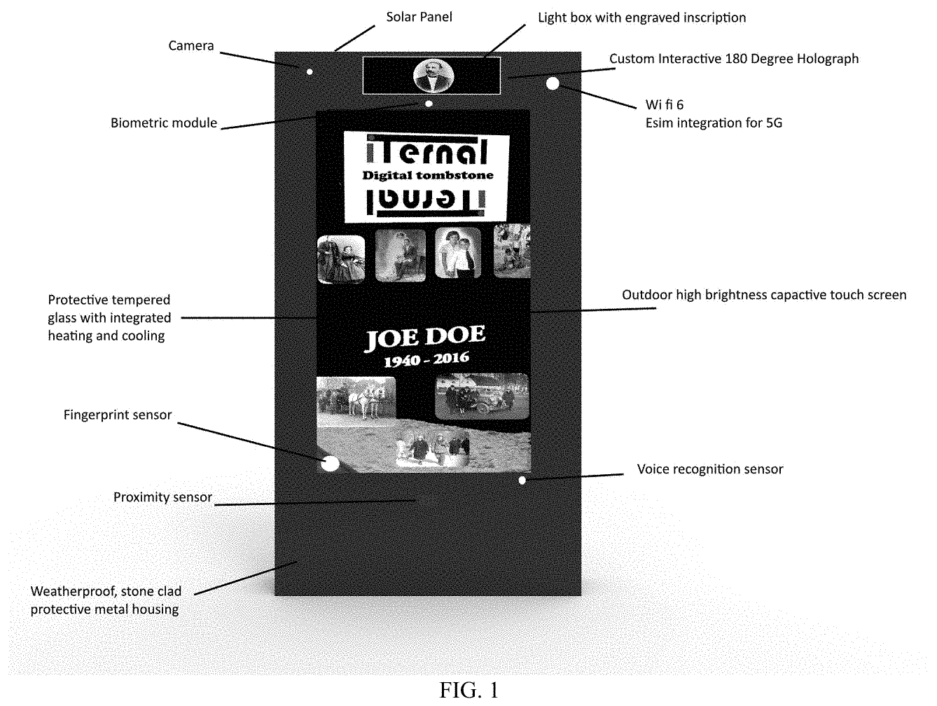

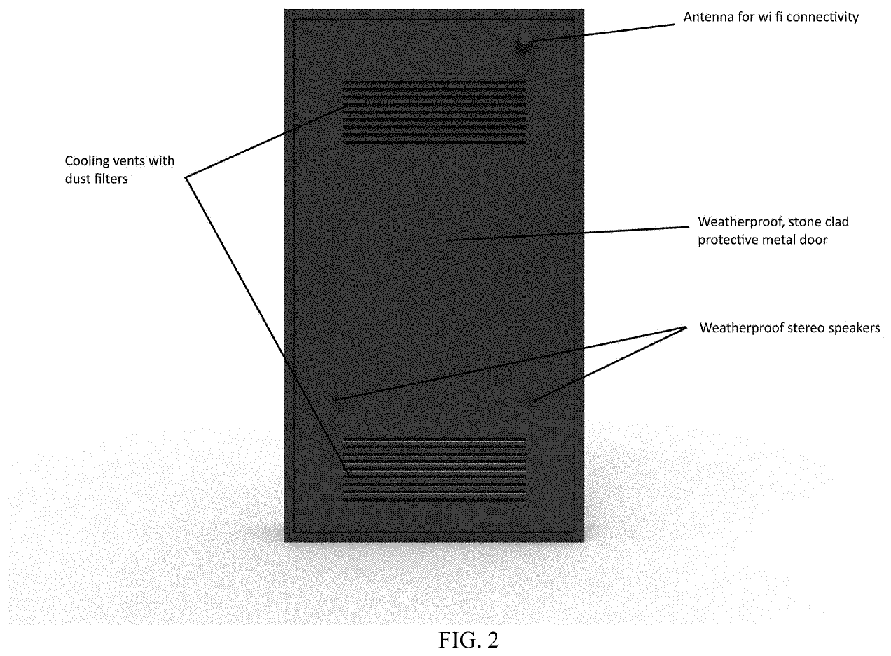

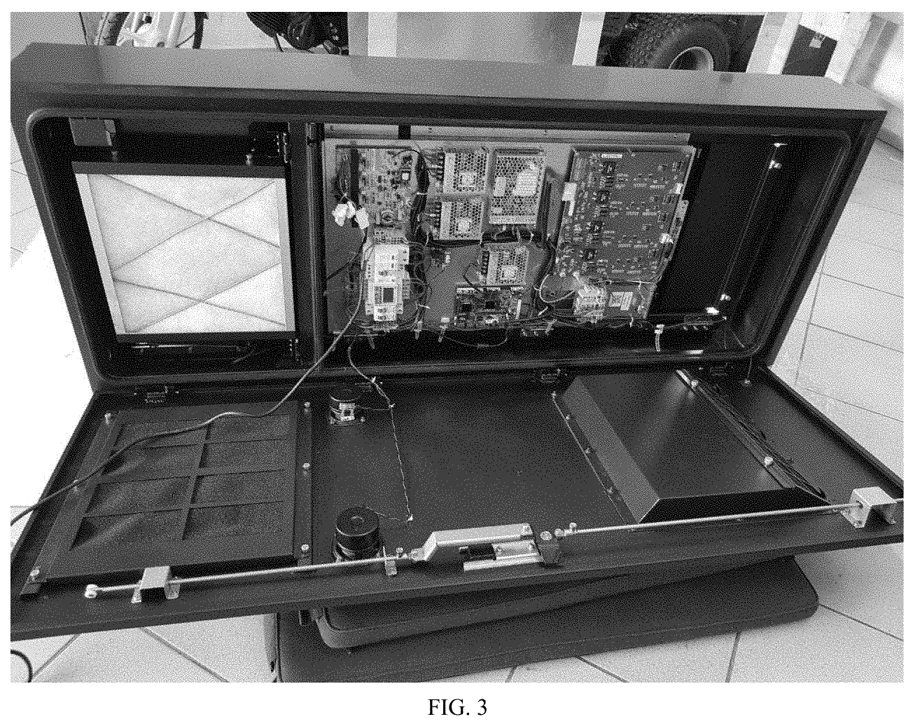

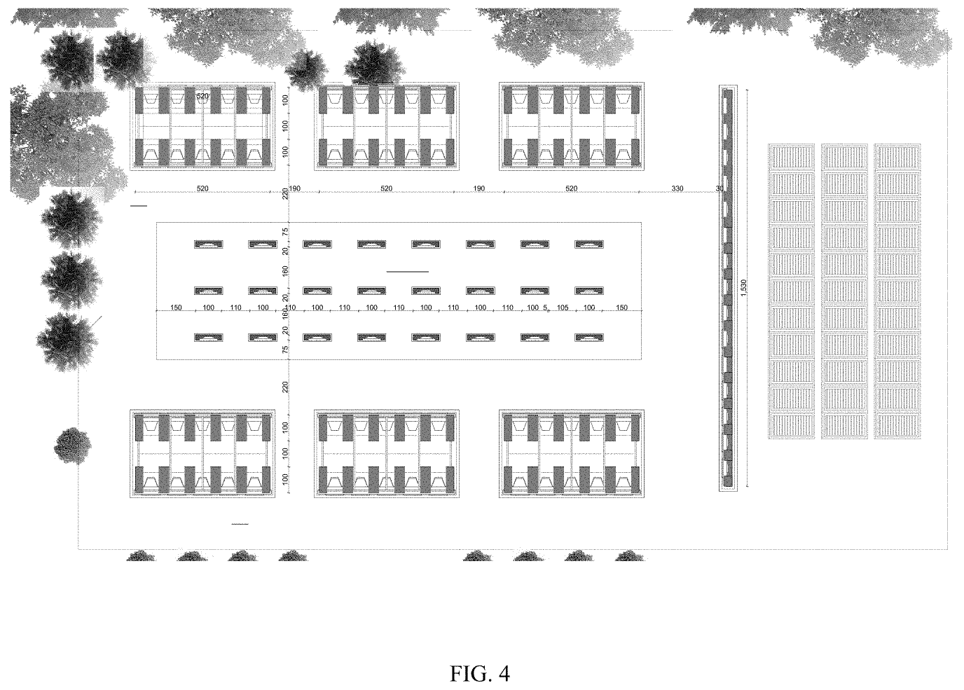

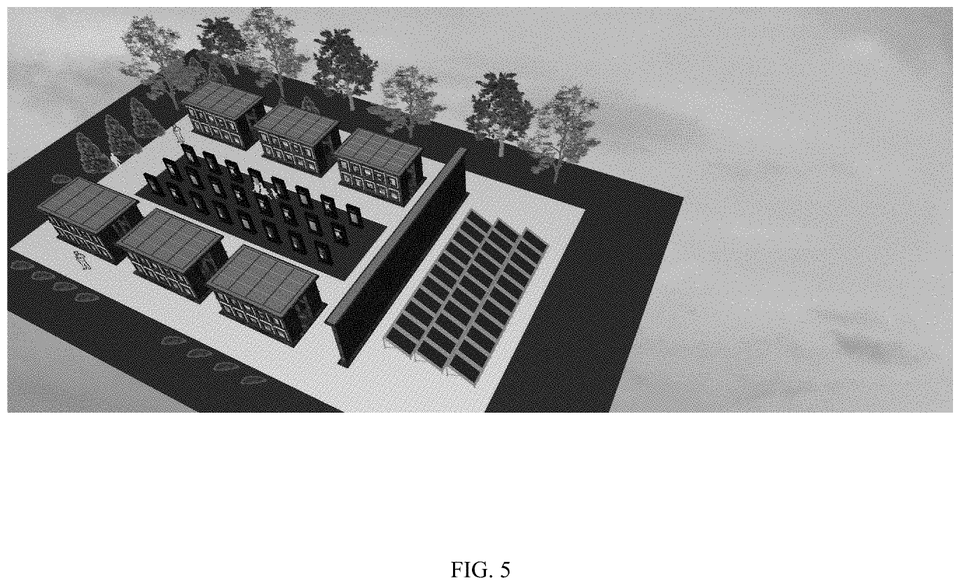

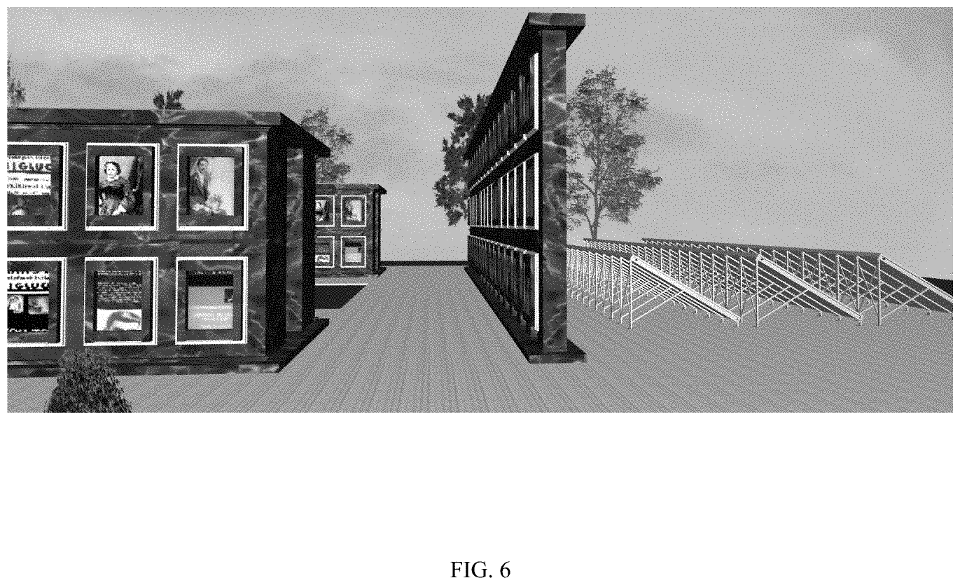

### DETAILED DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising”, when used herein, specify the presence of stated features, steps, operations, elements, various embodiments, and/or components, but do not preclude the presence or addition of one or more other features, steps, operations, elements, various embodiments, components, and/or groups thereof.

Unless otherwise defined, all terms (including technical and scientific terms) used herein have the same meaning as commonly understood by one having ordinary skill in the art to which this invention belongs. It will be further understood that terms, such as those used in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques, embodiments and/or steps are disclosed. Each of these has individual benefit and each can also be used in conjunction with one or more, or in some cases all, of the other disclosed techniques, embodiments and/or steps. Accordingly, for the sake of clarity, the present disclosure will refrain from repeating every possible combination of the individual steps, techniques or embodiments in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident however, to one skilled in the art, that the present invention may be practiced with or without these details or with other similar or otherwise suitable details.

The present disclosure is to be considered as an exemplification of the invention, and it is not intended to limit the invention to the specific embodiments illustrated by the figures or descriptions.

The present invention is a solar powered, digital, interactive memorial installation that may be installed in place of a traditional gravestone. In general, in the preferred embodiment, the present invention comprises at least one memorial unit 1, at least one solar panel 2, and at least one power storage unit 3. Each memorial unit 1 is electrically connected to one of the power storage units 3, and each solar panel 2 is electrically connected to at least one of the power storage units 3. The wording of “at least one” component used herein should be understood to designate a group of indeterminate number, but greater than zero. Further, to explain for the sake of clarity, herein throughout groups of “at least one component”, for example, may be referred to by the aforementioned group name, exactly; thus referring to, for example, “the at least one component.”

A single memorial unit 1 may be understood to correspond with a base embodiment 100, or gravestone configuration, of the present invention, while configurations of multiple memorial units 1 arranged together with each other may be realized in various more advanced embodiments.

The at least one solar panel 2 is a primary source of electrical power for the present invention. The solar panels 2 are used to convert incident light energy from the sun into electricity that can be used to electrically power the present invention. In some embodiments, the solar panels 2 are positioned on the top side 42 of the housing 4, though the position of the solar panels 2 may vary in different embodiments.

In the preferred embodiment of the present invention, each memorial unit 1 comprises a housing 4, a digital display 5, an illuminated display recess 6, at least one sensor 7, a wireless communication device 8, and a processing unit 9. Further, the housing 4 comprises a front face 41, a top side 42, and a bottom side 43. In the base embodiment 100, the housing 4 further comprises a rear face 44 opposite the front face 41.

In the preferred embodiment, the digital display 5, the illuminated display recess 6, the at least one sensor 7, and the proximity sensor 71 are each connected to or through the housing 4 adjacent to the front face 41. The illuminated display recess 6 is further positioned adjacent to the top side 42, above the digital display 5, which is positioned generally central on the front face 41. The at least one sensor 7 comprises a motion sensor 70, and the motion sensor 70 is positioned adjacent to the front face 41 of the housing 4. The motion sensor 70 facilitates detection of the presence of a person in the vicinity of the present invention in order to activate various interactive functionalities of the present invention, which will be discussed later on herein.

The processing unit 9 is electronically connected to the digital display 5, each sensor 7, and the wireless communication device 8. The digital display 5, the illuminated display recess 6, each sensor 7, the processing unit 9, and the wireless communication device 8 are each electrically connected to one of the power storage units 30.

The housing 4 is the primary structural body of the memorial units 1 that locates, support, and/or encloses the various components of the memorial unit 1. In the preferred embodiment, the housing 4 is constructed with weather resistant or weatherproof materials, means, and/or methods in order to withstand exposure to a variety of weather conditions for an extended period of time. Preferably, the housing 4 is generally rectangular in shape, though this is not a strict requirement, and the housing 4 may have different geometries in different embodiments. The housing 4 may be constructed of any suitable material, such as, but not limited to, metal, polymer, stone, or other materials as desired.

The digital display 5 is the primary feature of the present invention, upon which various digital images, videos, or other visual elements may be depicted according to various static or interactive functionalities of the present invention. Preferably, the digital display 5 occupies the majority of the surface area of the front face 41 of the housing 4. In the preferred embodiment, the digital display 5 is a touchscreen display. The touchscreen display is more particularly electrically connected to one of the power storage units 30, and electronically connected to the processing unit 9. The touchscreen display allows a user to browse through and choose from accessible content stored on the present invention, in addition to any relevant interactivity purposes. In various circumstances, the touchscreen display may simply display one or more static visual elements, such as the deceased's name, date of birth, date of death, and the like, or the touchscreen may be activated to display various dynamic, interactive, or other visual elements.

The illuminated display recess 6, or light box, is provided as a small area on the front face 41 of the housing 4 to display a desired visual element, such as an engraved inscription, a photograph, a piece of memorabilia, or the like. In some embodiments, the illuminated display recess 6 may present different visual elements depending on user customization of the illuminated display recess 6.

In the preferred embodiment, each memorial unit 1 of the present invention further comprises a tempered glass layer 11. The tempered glass layer 11 is connected to the front face 41 of the housing 4, over the digital display 5 and the illuminated display recess 6. The tempered glass layer 11 serves to physically protect the digital display 5, the illuminated display recess 6, and other components from the elements, vandalism, and other potential hazards. The tempered glass layer 11 is preferably a type of safety glass processed by controlled thermal or chemical treatments to increase its strength compared to standard glass.

In the preferred embodiment, the at least one sensor 7 comprises at least one biometric sensor 72. It is contemplated that in various embodiments, various types of biometric sensors 72 may be included without limit in various combinations in order to enable one or more biometric recognition features and/or functionalities for the present invention. In some embodiments, alternatively, a biometric module may be comprised, which may be a purpose-built unitary component configured to accomplish various biometric recognition functionalities, which may comprise a fingerprint solution and a face recognition solution. In some embodiments, the at least one biometric sensor 72 comprises a fingerprint sensor 73. The location of the fingerprint sensor 73 may vary in different embodiments, but in the preferred embodiment, the fingerprint sensor 73 is positioned adjacent to the front face 41 of the housing 4, adjacent to the digital display 5, and sufficiently exposed to the surrounding environment to enable scanning a fingerprint of a user or visitor. The fingerprint sensor 73 allows biometric recognition of specific individuals in order to grant access to specific content designated for said specific individuals.

In some embodiments, the at least one biometric sensor 72 may comprise a facial recognition sensor 74. The facial recognition sensor 74 may vary as suitable and desired in different embodiments, but in most embodiments the facial recognition sensor 74 will comprise an optical sensor 75. It may further be noted that in some embodiments, more particularly, instead of a facial recognition sensor 74, a facial recognition module may be comprised by the present invention. The facial recognition module may, for example, be a modular component packaged with at least an optical sensor 75, a processor, and a facial recognition software algorithm, such that the facial recognition module is a unit that is capable of providing facial recognition capabilities to the present invention through inclusion of the facial recognition module alone.

In some embodiments, the at least one biometric sensor 72 may comprise a voice recognition sensor 76. The voice recognition sensor 76 may be used to identify a voice pattern of specific individuals, similar to the fingerprint sensor 73 and the facial recognition sensor 74. Preferably, the voice recognition sensor 76 is positioned adjacent to the front face 41 of the present invention. More specifically, the voice recognition is located underneath the right corner of the digital display 5, though the specific position of the voice recognition sensor 76 may vary in different embodiments. In some embodiments, the voice recognition sensor 76 functionality may be implemented simply through an audio microphone 77 electronically connected to the processing unit 9, which processes audio captured through the microphone 77 with one or more voice recognition algorithms.

In the preferred embodiment, the at least one sensor 7 comprises a camera 78. In some embodiments, the camera 78 is positioned adjacent to the front face 41 of the present invention, though the position of the camera 78 may vary in different embodiments. More specifically, the camera 78 is preferably positioned adjacent to the top side 42 and the front face 41 of the housing 4. In some embodiments, the camera 78 and the facial recognition sensor 74 may be one and the same. In some embodiments, the present invention may comprise both the camera 78 and a separate facial recognition sensor 74, or in some embodiments the present invention may comprise both the camera 78 and the aforementioned facial recognition module. The camera 78 is electrically connected to one of the power storage units 30 and electronically connected to the processing unit 9. The camera 78 is an optical device used to assist with detecting nearby users of the present invention. The camera 78 is used to capture images and/or videos of the user while positioned in front of the present invention. In addition, the camera 78 may be used as a theft or vandalism prevention or mitigation means to capture evidence of any persons who engage in vandalism or otherwise damage the present invention. Lastly, the camera 78 may be utilized with a biometric module.

As mentioned, the present invention provides a theft protection mechanic. The camera 78 installed is optional as it can be used to observe and protect the present invention from being vandalized or damaged. The camera 78 may stream a live video feed through the wireless communication device 8 to a user's personal devices such as smart phone, desktop or laptop computer, and the like. In addition, an alarm 14 installation feature is also an option to assist with real-time notification if the present invention is being vandalized, damaged, or the like.

In the preferred embodiment, as previously mentioned, the at least one sensor 7 further comprises a proximity sensor 71. In some embodiments the proximity sensor 71 may be a motion sensor 70, though in various embodiments the proximity sensor 71 may be any suitable type of proximity sensor 71. The main purpose of the proximity sensor 71 is to conserve electrical energy. If motion is not detected by the proximity sensor 71 for a specified length of time, various electricity-consuming features of the present invention, notably the digital display 5, may be deactivated until the proximity sensor 71 detects a user's presence in the vicinity. Thus, the present invention minimizes its ecological footprint, saving energy and reducing light pollution.

As mentioned, the proximity sensor 71 comprises a motion sensor 70. The motion sensor 70 will detect any motion nearby and activate the major functions of the present invention, notably the digital display 5. The motion sensor 70 and proximity sensor 71 are included to conserve electricity and avoid unnecessarily draining the power storage unit 3 by turning off the present invention to save energy when no users are nearby. The proximity sensor 71 and motion sensor 70 are located on the front face 41 of the present invention. More specifically, the proximity sensor 71 and motion sensor 70 are centered underneath the digital display 5 in the preferred embodiment, though this location may change in different embodiments.

In the preferred embodiment, the present invention further comprises an antenna as the wireless communication device 8. The antenna may be connected adjacent to the rear face 44 of the housing 4 in some embodiments, though this is not a strict requirement, and the location of the antenna may change as desired. The antenna provides wireless electronic connectivity between the processing unit 9 and any other desired computational entity over any suitable wireless communication network, such as, but not limited to, cellular networks, Wi-Fi networks, Bluetooth connections, or other suitable connections.

Preferably, the present invention is remotely and electronically communicably coupled through the wireless communication device 8 with a remote computing entity, such as, but not limited to, a remote server. This preferably further provides a backend login functionality or online control dashboard functionality to users of the present invention, who may use the dashboard or other user interface to upload audio or visual elements or designate portions of text to be displayed. In some embodiments, such elements must be approved by an administrator account before they are allowed to be displayed.

In some embodiments, the biometric recognition functionality of the present invention allows specified individuals who are in the vicinity of the present invention to be biometrically recognized and granted access to upload and/or edit content displayed on the digital display 5 or other similar content. Different classes of biometrically recognizable users may be afforded different levels of interaction permissions.

In the preferred embodiment, the present invention comprises at least one speaker 12. Each speaker 12 is electrically connected to one of the power storage units 30, and each speaker 12 is electronically connected to the processing unit 9. Preferably, each speaker 12 is connected adjacent to the rear face 44 of the housing 4. However, this is not considered a strict requirement, and the location of the at least one speaker 12 may vary in different embodiments as desired. The speakers 12 may be used to play any desirable audio elements, such as, but not limited to, prerecorded messages from the deceased, audio biographical information, instructions to the user, or other audio elements.

An additional desired feature of the present invention, though not required in all embodiments, is a hologram projector unit 13. The hologram projector unit 13 is preferably connected adjacent to the front side of the housing 4. Further, the hologram projector unit 13 may be positioned adjacent to, or even coincident with, the illuminated display recess 6. The hologram projector unit 13 is electrically connected to one of the power storage units 30 and electronically connected to the processing unit 9. The hologram projector unit 13 may be functionally integrated with the camera 78 or other sensors in order to be interactive with a user. The hologram projector unit 13 may present an interactive presentation of what is deemed to be important of the deceased, or any other suitable content. The hologram projector unit 13 is preferably positioned adjacent to the front face 41 of the present invention. More specifically, the hologram projector unit 13 is located and centered adjacent to the top side 42 and the front face 41, similarly to the illuminated display recess 6.

The preferred embodiment of the present invention, more particularly the base embodiment 100, further comprises a plurality of temperature regulation vents 45. While it is contemplated that the location of the plurality of temperature regulation vents 45 may vary without limit in different embodiments, preferably, in the base embodiment 100, the plurality of temperature regulation vents 45 is positioned on the rear face 44 of the housing 4 and traverses through the rear face 44. The plurality of temperature regulation vents 45 may be manufactured integral to the housing 4, or the plurality of temperature regulation vents 45 may comprise components separate from the housing 4 that are installed into the housing 4, or the plurality of temperature regulation vents 45 may be embodied through any other desirable means. The plurality of temperature regulation vents 45 provides an interior cavity 48 of the housing 4 with an airflow connection to the surrounding environment, thus keeping any components within the interior cavity 48 cool should excess heat be generated within the interior cavity 48.

Further, a plurality of filters 46 may correspondingly be comprised with the plurality of temperature regulation vents 45. The plurality of filters 46 serve to filter the airflow passing through the plurality of temperature regulation vents 45, preventing dust, debris, and other undesirable foreign matter from encroaching into the interior of the housing 4 and potentially damaging the electronic components of the present invention. Each of the plurality of filters 46 is positioned adjacent to one of the temperature regulation vents 45. The plurality of filters 46 may be embodied in any suitable fashion. In some embodiments, each of the plurality of filters 46 is affixed to the housing 4 within the interior cavity 48 over one of the plurality of temperature regulation vents 45 through a removably frame that is affixed to the interior of the housing 4 through a plurality of fasteners and captures a filter media therein. In some embodiments, each of the plurality of filters 46 may be a removably cartridge style filter that may be slidably inserted into a designated filter slot, for example, or another suitable arrangement may be implemented for the plurality of filters 46.

In the preferred embodiment, the housing 4 of each memorial unit 1 further comprises an access closure 47. The access closure 47 is operatively connected adjacent to a rear face 44 of the housing 4, such that the access closure 47 regulates access to the internal cavity of the housing 4 for maintenance, repairs, or other similar activities requiring access to the components of the present invention within the internal cavity.

In the preferred embodiment, each memorial unit 1 of the present invention further comprises an alarm 14. The alarm 14 may be implemented through any suitable alarm 14 sounding device that is typical, known in the art, or new.

In the preferred embodiment, the present invention provides various computer-administered functionalities through the various electronic components of the present invention. Such computer control is executed by the processing unit 9, or any other suitable component.

One desirable functionality of the present invention is to provide a digital will reading functionality, which may be utilized to communicate the contents of the deceased's will to present users, or to specific individuals depending on biometric recognition. The will reader functionality provides a poignant, personal means of communicating the last will of the deceased as opposed to the traditional method of having an attorney or the like reading and communicating the will to the deceased's close family, friends, and/or other loved ones. The present invention may play prerecorded media at areas of mourning. The presented content may have an appearance suitable for areas of mourning, allowing family and friends of the deceased to feel closeness to the deceased while the will is being read. The present invention can also play prerecorded media, allowing the playing of a prerecorded video of the deceased reading their own last will. The playing of the video of the deceased reading their last will personalizes the process of having the last will being read.

Another desirable functionality of the present invention is to provide a funeral ceremony performing functionality, which is utilized to conduct and share the experience of a funeral of the deceased while they are still alive. An individual can organize and prerecord their own funeral ceremony while still alive. The recorded ceremony is played at the funeral on the digital display 5 of the present invention. The present invention allows the deceased to address their relatives and friends as well as sharing last experiences and parting words during the funeral performance. In addition, relatives and friends can prepare a digital funeral ceremony for the deceased.

The present invention has been described heretofore as a singular, standalone memorial unit 1. In the base embodiment 100, the housing 4 may be integrated into a gravestone-like structure constructed of natural or imitation marble or the like. As previously mentioned, the present invention may additionally be configured into arrangements with multiple memorial units 1. Additional embodiments may be implemented that include multiple memorial units 1 arranged together in certain configurations. Although the present invention should be understood to not be limited to the following, two such configurations to be described hereinafter are a columbarium configuration 200 and a memorial wall configuration 300. In both the columbarium configuration 200 and the memorial wall configuration 300, the initially disclosed at least one memorial unit 1 comprises a plurality of memorial units 10.

In the base embodiment 100, only a single solar panel 2 may be required as the at least one solar panel 2, and only a single power storage unit 3 may be comprised as the at least one power storage unit 3. Thus, a single solar panel 2 may charge the power storage unit 3, or battery, during periods of sun, and the battery should be of sufficient capacity to sustain electrical power delivery the present invention in the absence of incident sunlight energy to the solar panel 2. Alternatively, multiple solar panels 2 and/or multiple power storage units 30 may be implemented for the singular base gravestone embodiment 100, as suitable and desired.

In the columbarium configuration 200 and the memorial wall configuration 300, a plurality of solar panels 20 may be comprised as the at least one solar panel 2, while multiple power storage units 30 may be comprised as the at least one storage unit in order to adequately meet the respective increased power requirements of the multiple units. Each memorial unit 1 may have its own power storage unit 3, or all the memorial units 1 may be collectively connected to and share the collective capacity of the plurality of power storage units 30. The plurality of solar panels 20 and the plurality of power storage units 30 may be positioned and configured in any desirable manner.

A columbarium is a structure for the respectful and usually public storage of funerary urns, holding cremated remains of the deceased. Columbariums are generally characterized by one or more walls or similar bodies or structures containing many niches traversing generally horizontally into the wall, within which funerary urns are typically placed. This, in the columbarium configuration 200, a columbarium structure is further comprised by the present invention. The columbarium structure may be, but is not limited to, a wall structure, a rectangular prismatic structure, or any other structure with suitable geometry for achieving the aforementioned intended purpose. The columbarium structure of the present invention comprises at least one columbarium display face 210 and a plurality of niches 220. Each niche is a cavity extending into the columbarium display face 210. The plurality of niches 220 are distributed across the columbarium display faces 210, and each of the plurality of memorial units 10 is positioned within one of the plurality of niches 220. Each of the memorial units 1 will correspond to a different deceased person. Thus, the base embodiment 100 of the singular memorial unit 1 of the present invention may be adapted in and expanded into a more complex arrangement with multiple memorial units 1, for example for use in a public setting to allow relatives, friends, and other loved ones of deceased individuals to visit and pay respects. Preferably, in the columbarium configuration 200, when the motion sensor 70 detects a visitor's approach, each of the plurality of memorial units 10 is correspondingly activated. More particularly, the digital display 5 and/or other components may be activated upon a visitor's approach. To this end, the processing unit 9 of each of the plurality of memorial units 10 may be communicably coupled with each other, or alternatively, a singular master processing unit 9 may be responsible for controlling all of the memorial units 1. Otherwise, each memorial unit 1 operates independently of each other, particularly in regard to interaction with the touchscreen displays of the memorial units 1.

It should be noted that a deceased individual's remains need not necessarily be stored in the same location as their respective memorial unit 1, though such an arrangement is not excluded either in the present invention.

In a similar fashion, as previously mentioned, the present invention further comprises a memorial wall configuration 300. A memorial wall is a wall typically engraved with a plurality of names or other information in order to commemorate a number of people whose death shared a common attribute, such as being killed in a single or protracted violent conflict, or a disaster, or by the same disease, or the like.

In the memorial wall configuration 300 of the present invention, the at least one memorial unit 1 again comprises a plurality of memorial units 10, wherein the plurality of memorial units 10 is arranged into the memorial wall configuration 300. In the memorial wall configuration 300, a memorial wall structure 310 is comprised, the memorial wall structure 310 comprising at least one memorial wall display face 320. The plurality of memorial units 10 is connected within the memorial wall structure 310 adjacent to the memorial wall display face 320, and the plurality of memorial units 10 is distributed across the memorial wall structure 310. Preferably, the memorial wall configuration 300 functions similarly to the columbarium configuration 200, though this is not necessarily a requirement and various control and functionality schemes may be implemented in various embodiments as desired.

Although the invention has been explained in relation to its preferred embodiment, it is to be understood that many other possible modifications and variations can be made without departing from the spirit and scope of the invention as hereinafter claimed.

What is claimed is:

1. A solar powered digital interactive memorial comprising:
at least one memorial unit;
at least one solar panel;
at least one power storage unit;
each memorial unit being electrically connected to one of the power storage units;
each solar panel being electrically connected to at least one of the power storage units;
each memorial unit comprising a housing, a digital display, an illuminated display recess, at least one sensor, a wireless communication device, and a processing unit;
the housing comprising a front face, a top side, and a bottom side;
the digital display, the illuminated display recess, the at least one sensor, and the proximity sensor being connected adjacent to the front face;
the illuminated display recess being positioned adjacent to the top side;
the digital display being positioned centrally on the front face;
the at least one sensor comprising a motion sensor;
the motion sensor being positioned adjacent to the front face of the housing;
the processing unit being electronically connected to the digital display, each sensor, and the wireless communication device; and
the digital display, the illuminated display recess, each sensor, the processing unit, and the wireless communication device being electrically connected to one of the power storage units.

2. The solar powered digital interactive memorial as claimed in claim 1 comprising:
the digital display being a touchscreen display;
the touchscreen display being electrically connected to one of the power storage units; and
the touchscreen display being electronically connected to the processing unit.

3. The solar powered digital interactive memorial as claimed in claim 1 comprising:
a tempered glass layer; and
the tempered glass layer being connected to the front side of the housing, over the digital display and the illuminated display recess.

4. The solar powered digital interactive memorial as claimed in claim 1 comprising:
the at least one sensor comprising at least one biometric sensor.

5. The solar powered digital interactive memorial as claimed in claim 4 comprising:
the at least one biometric sensor comprising a fingerprint sensor; and
the fingerprint sensor being positioned adjacent to the front face of the housing, adjacent to the digital display.

6. The solar powered digital interactive memorial as claimed in claim 4 comprising:
the at least one biometric sensor comprising a facial recognition sensor.

7. The solar powered digital interactive memorial as claimed in claim 4 comprising:
the at least one biometric sensor comprising a voice recognition sensor.

8. The solar powered digital interactive memorial as claimed in claim 1 comprising:
the at least one sensor comprising a camera;
the camera being electrically connected to one of the power storage units; and
the camera being electronically connected to the processing unit.

9. The solar powered digital interactive memorial as claimed in claim 1 comprising:
the wireless communication device comprising an antenna; and
the antenna being connected adjacent to a rear face of the housing.

10. The solar powered digital interactive memorial as claimed in claim 1 comprising:
at least one speaker;
each speaker being electrically connected to one of the power storage units; and
each speaker being electronically connected to the processing unit.

11. The solar powered digital interactive memorial as claimed in claim 10 comprising:
the housing further comprising a rear face opposite the front face; and
each speaker being connected adjacent to the rear face of the housing.

12. The solar powered digital interactive memorial as claimed in claim 1 comprising:
a hologram projector unit;
the hologram projector unit being connected adjacent to the front side of the housing;
the hologram projector unit being electrically connected to one of the power storage units; and
the hologram projector unit being electronically connected to the processing unit.

13. The solar powered digital interactive memorial as claimed in claim 1 comprising:
a plurality of temperature regulation vents; and
the plurality of temperature regulation vents traversing through the rear face of the housing.

14. The solar powered digital interactive memorial as claimed in claim 13 comprising:
a plurality of filters; and
each of the plurality of filters being positioned adjacent to one of the temperature regulation vents.

15. The solar powered digital interactive memorial as claimed in claim 1 comprising:
an access closure; and
the access closure being operatively connected adjacent to a rear face of the housing, wherein the access closure regulates access to an internal cavity of the housing.

16. The solar powered digital interactive memorial as claimed in claim 1 comprising:
an alarm;
the alarm being electrically connected to one of the power storage units; and
the alarm being electronically connected to the processing unit.

17. The solar powered digital interactive memorial as claimed in claim 1 comprising:
the at least one memorial unit comprising a plurality of memorial units, wherein the plurality of memorial units is arranged into a columbarium configuration;
a columbarium structure comprising a plurality of niches and at least one columbarium display face;
the plurality of niches traversing through the columbarium display face into the columbarium structure; and
the plurality of niches being distributed across the columbarium display face;
each of the plurality of memorial units being positioned within one of the plurality of niches.

18. The solar powered digital interactive memorial as claimed in claim 1 comprising:
the at least one memorial unit comprising a plurality of memorial units, wherein the plurality of memorial units is arranged into a memorial wall configuration;
a memorial wall structure comprising at least one memorial wall display face;
the plurality of memorial units being connected within the memorial wall structure adjacent to the memorial wall display face; and
the plurality of memorial units being distributed across the memorial wall structure.
